(19) United States
(12) Patent Application Publication
(10) Pub. No.: US 2025/0069614 A1
(43) Pub. Date: Feb. 27, 2025

(54) SIGNAL FILTERING APPARATUS, SIGNAL FILTERING METHOD AND PROGRAM

(71) Applicant: NIPPON TELEGRAPH AND TELEPHONE CORPORATION, Tokyo (JP)

(72) Inventors: Yasunori OISHI, Musashino-shi, Tokyo (JP); Marc DELCROIX, Musashino-shi, Tokyo (JP); Tsubasa OCHIAI, Musashino-shi, Tokyo (JP); Shoko ARAKI, Musashino-shi, Tokyo (JP); Daiki TAKEUCHI, Musashino-shi, Tokyo (JP); Daisuke NIIZUMI, Musashino-shi, Tokyo (JP); Akisato KIMURA, Musashino-shi, Tokyo (JP); Noboru HARADA, Musashino-shi, Tokyo (JP); Kunio KASHINO, Musashino-shi, Tokyo (JP)

(73) Assignee: NIPPON TELEGRAPH AND TELEPHONE CORPORATION, Tokyo (JP)

(21) Appl. No.: 18/724,410

(22) PCT Filed: Dec. 27, 2021
(86) PCT No.: PCT/JP2021/048689

§ 371 Date: Jun. 26, 2024

(51) Int. Cl. G10L 21/0216; G10L 15/02; G10L 21/0208; G10L 21/028

(52) U.S. Cl. CPC G10L 21/0216; G10L 15/02; G10L 21/028; G10L 2021/02087

(57) ABSTRACT

A signal filtering device includes: a separation unit that separates a predetermined number of possibility signals from a mixed signal as possibilities of a target signal; an encoding unit that encodes related information of the target signal into a first feature vector and encodes the predetermined number of possibility signals into the predetermined number of second feature vectors; and a selection unit that derives a similarity between the first feature vector and the second feature vector for each of the possibility signals, and selects a possibility signal of the possibility signals having the highest similarity as the target signal from the predetermined number of possibility signals. The selection unit may derive an inner product of the first feature vector and the second feature vector as the similarity. The predetermined number of possibility signals may be voice signals associated with the predetermined number of sound sources. The separation unit may separate the possibility signals in the mixed signal for each of the sound sources.

### TECHNICAL FIELD

The present invention relates to a signal filtering device, a signal filtering method, and a program.

### BACKGROUND ART

When a plurality of speakers speak, voices of the speakers may be mixed. The effect of being able to hear the voice of a speaker selected from the mixed voices is known as a cocktail party effect. It has been studied to achieve this cocktail party effect by a signal filtering device.

Hereinafter, the voice signal may be a signal corresponding to a voice language or a signal (acoustic signal) corresponding to an audio of a musical instrument or the like. The signal filtering device extracts or removes a specific part or element in the voice signal input to the signal filtering device from the voice signal by filtering processing on the voice signal. That is, the signal filtering device extracts or removes the voice signal (hereinafter, referred to as a “target voice signal”) intended for extraction from the mixed voice signal.

The signal filtering device disclosed in Non Patent Literature 1 performs filtering processing on the basis of physical characteristics of a target voice signal. The physical characteristics are a direction of a sound source, a harmonic structure of a frequency component of a voice, statistical independence of a voice signal, and tone proximity or consistency of a target speaker.

### CITATION LIST

### Non Patent Literature

Non Patent Literature 1: K. Zmolikova, M. Delcroix, K. Kinoshita, T. Ochiai, T. Nakatani, L. Burget, and J. Cernocky, “SpeakerBeam: Speaker Aware Neural Network for Target Speaker Extraction in Speech Mixtures”, IEEE Journal of Selected Topics in Signal Processing, vol. 13, no. 4, pp. 800-814, 2019.

### SUMMARY OF INVENTION

### Technical Problem

However, there is a problem that the accuracy of extracting a target voice signal from a voice signal in which a voice signal other than the target voice signal and the target voice signal are mixed cannot be improved.

In view of the above circumstances, an object of the present invention is to provide a signal filtering device, a signal filtering method, and a program capable of improving accuracy of extracting a target voice signal from a voice signal obtained by mixing a voice signal other than the target voice signal and the target voice signal.

### Solution to Problem

An aspect of the present invention is a signal filtering device including: a separation unit that separates a predetermined number of possibility signals from a mixed signal as possibilities of a target signal; an encoding unit that encodes related information of the target signal into a first feature vector and encodes the predetermined number of possibility signals into the predetermined number of second feature vectors; and a selection unit that derives a similarity between the first feature vector and the second feature vector for each of the possibility signals, and selects a possibility signal of the possibility signals having the highest similarity as the target signal from the predetermined number of possibility signals.

An aspect of the present invention is a signal filtering method performed by a signal filtering device, the signal filtering method including steps of: separating a predetermined number of possibility signals from a mixed signal as possibilities of a target signal; encoding related information of the target signal into a first feature vector and encoding the predetermined number of possibility signals into the predetermined number of second feature vectors; and deriving a similarity between the first feature vector and the second feature vector for each of the possibility signals, and selecting a possibility signal of the possibility signals having the highest similarity as the target signal from the predetermined number of possibility signals.

An aspect of the present invention is a program for causing a computer to function as the signal filtering device described above.

### Advantageous Effects of Invention

According to the present invention, it is possible to improve the accuracy of extracting a target voice signal from a voice signal in which a voice signal other than the target voice signal and the target voice signal are mixed.

### BRIEF DESCRIPTION OF DRAWINGS

FIG. 1 is a diagram illustrating an exemplary configuration of a signal filtering device according to a first embodiment.

FIG. 2 is a flowchart illustrating an exemplary operation of the signal filtering device according to the first embodiment.

FIG. 3 is a diagram illustrating an exemplary configuration of the signal filtering device according to a second embodiment.

FIG. 4 is a diagram illustrating an example of a similarity profile according to the second embodiment.

FIG. 5 is a flowchart illustrating an exemplary operation of the signal filtering device according to the second embodiment.

FIG. 6 is a diagram illustrating an exemplary configuration of a signal filtering device according to a third embodiment.

FIG. 7 is a flowchart illustrating an exemplary operation of the signal filtering device according to the third embodiment.

FIG. 8 illustrates examples of signal-to-distortion ratio scores averaged for a target voice signal in the first embodiment and the second embodiment.

FIG. 9 illustrates an example of extracting a target voice signal in the second embodiment.

FIG. 10 illustrates an example of a signal-to-distortion ratio score for each overlap ratio in the second embodiment and the third embodiment.

FIG. 11 is a diagram illustrating an exemplary hardware configuration of the signal filtering device according to each embodiment.

### DESCRIPTION OF EMBODIMENTS

### Outline

Hereinafter, a voice signal in which a voice signal other than a target voice signal and the target voice signal are mixed is referred to as a “mixed voice signal”. Hereinafter, a function of extracting a target voice signal from a mixed voice signal on the basis of a concept specified by a predetermined method is referred to as a “concept beam” (ConceptBeam). The predetermined method is not limited to a specific method, but is, for example, a method of specifying using a voice signal, a still image signal, a moving image signal (video signal), or a text signal (explanation signal). The target voice signal is a specific portion or element in the mixed voice signal.

For example, a mixed voice signal by a plurality of speakers speaking different topics is input to the signal filtering device. In addition, a signal (hereinafter, referred to as a “concept specification signal”) for specifying a concept intended for extraction is input to the signal filtering device.

The signal filtering device extracts semantic information in a multidimensional vector format, that is, concept information (hereinafter, referred to as a “concept embedding vector”) in a multidimensional vector format from the concept specification signal. A voice language related to a concept (latent semantic information) specified by using the concept specification signal may be included in the mixed voice signal. For example, waveform data (voice language) of the word “bicycle” related to a bicycle image in a frame of a still image as the concept specification signal may be included in the mixed voice signal.

The signal filtering device extracts, from the mixed voice signal, a target voice signal from a speaker talking about a concept intended for extraction. For example, when an image signal of a bicycle is input to the signal filtering device, the signal filtering device extracts, from the mixed voice signal, a target voice signal by a speaker speaking about the concept “bicycle” intended for extraction.

In the first and second embodiments described below, the signal filtering device applies cross-modal expression learning (Reference Literature 1: D. Harwath, A. Recasens, D. Suris, G. Chuang, A. Torralba, and J. Glass, “Jointly discovering visual objects and spoken words from raw sensory input”, International Journal of Computer Vision, 2019.). Accordingly, the signal filtering device expresses the concept specified using the concept specification signal using the concept embedding vector (concept vector).

In the first embodiment and the second embodiment described below, the signal filtering device applies a method of extracting a target speaker (Reference Literature 2: M. Delcroix, K. Zmolikova, T. Ochiai, K. Kinoshita, and T. Nakatani, “Speaker activity driven neural speech extraction”, in Proc. ICASSP, 2021.). Accordingly, the signal filtering device extracts the target voice signal from the mixed voice signal on the basis of the concept expressed using the concept embedding vector.

In a third embodiment described below, the signal filtering device applies a method of separating sound sources (Reference Literature 3: M. Kolbak, D. Yu, Z.-H. Tan, and J. Jensen, “Multi-talker Speech Separation with Utterance-level Permutation Invariant Training of Deep Recurrent Neural Networks”, IEEE/ACM Transactions on Audio, Speech and Language Processing, vol. 25, no. 10, pp. 1901-1913, 2017.). Thus, the signal filtering device extracts the target voice signal from the mixed voice signal.

Embodiments of the present invention will be described in detail with reference to the drawings.

Hereinafter, a symbol added above a character in a mathematical expression is described immediately before the character. For example, the symbol “\hat{ }” added above the character “X” in the mathematical expression is described immediately before the character “X” such as “\hat{ }X”. For example, the symbol “ ” added above the character “I” in the mathematical expression is described immediately before the character “I”, such as “( )I”.

### First Embodiment

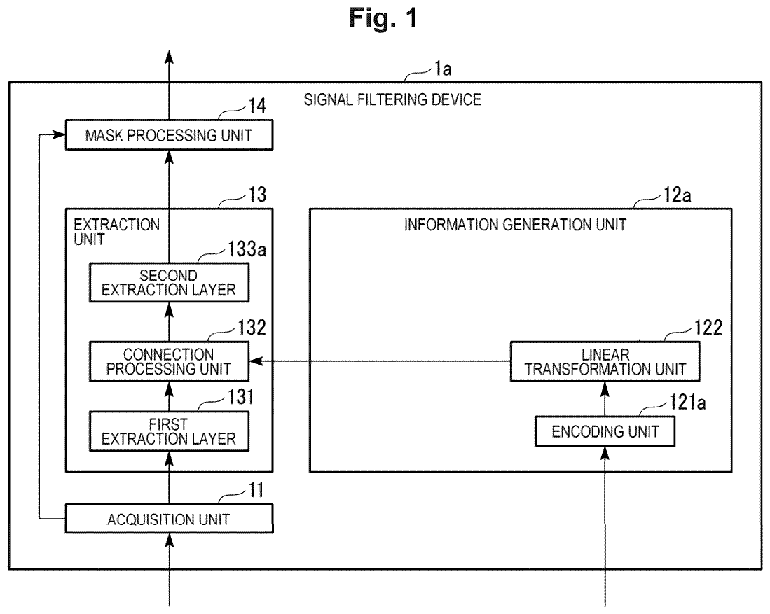

FIG. 1 is a diagram illustrating an exemplary configuration of a signal filtering device 1a according to a first embodiment. The signal filtering device 1a is a device that extracts the target voice signal from the mixed voice signal. The signal filtering device 1a extracts the target voice signal from the mixed voice signal by filtering the mixed voice signal including the voice signal other than the target voice signal and the target voice signal. In the first embodiment, as an example, the signal filtering device 1a uses a concept embedding vector (embedding vector of an image) obtained using an audiovisual (image and voice) embedded network (neural network) as a clue for extracting the target voice signal from the mixed voice signal.

The signal filtering device 1a includes an acquisition unit 11, an information generation unit 12a, an extraction unit 13, and a mask processing unit 14. The information generation unit 12a includes an encoding unit 121a and a linear transformation unit 122. The extraction unit 13 includes a first extraction layer 131, a connection processing unit 132, and a second extraction layer 133a.

### <Learning Stage>

An embedding vector of an image and an embedding vector of a voice are obtained on the basis of a large amount of pair data of the image and the voice describing the content of the image. In the learning stage before the estimation stage, the encoding unit 121a performs deep distance learning so that the embedding vector of the image and the embedding vector of the voice are arranged close to each other in the latent space (audiovisual embedding space).

Processing in which a target voice signal corresponding to a voice of a speaker speaking about a concept (content of a still image as a concept specification signal) intended for extraction is extracted from a mixed voice signal is formulated as in Expression (1).

$$\begin{matrix}[ Math . 1 ] & \\ {\hat{X}}_{k} = f ( Y , {C}_{k} ) , & ( 1 )\end{matrix}$$

Here, “Y∈C^{T×F}” represents the mixed voice signal (input signal) in the short-time Fourier transform region. “T” represents the number of frames per hour in the mixed voice signal. “F” represents the number of frequency bins of the mixed voice signal. “\hat{ }Xₖ∈C^{T×F}” represents the target voice signal of the k-th speaker. “f(⋅)” is a function representing processing (ConceptBeam) of extracting the target voice signal “\hat{ }Xₖ” from the mixed voice signal “Y” on the basis of a concept.

The parameter of the encoding unit 121a and the parameter of the extraction unit 13 may be learned at the same time, but are learned independently so as to be stable. In order for the information generation unit 12a and the extraction unit 13 to perform deep learning, a set “{Y, Xₖ, Cₖ}^{K}ₖ₌₁” including the mixed voice signal and the reference voice signal in the short-time Fourier transform region is necessary. Here, “Xₖ” represents a reference voice signal associated with the target voice signal of the k-th speaker. “Cₖ” represents a concept specification signal (for example, a still image). “K” represents the total number of speakers associated with the mixed voice signal.

The information generation unit 12a includes an audiovisual embedded network (for example, see Reference Literature 1). The information generation unit 12a generates an image feature vector (image feature information) on the basis of a concept specification signal (still image) input to the audiovisual embedded network. The information generation unit 12a generates a concept embedding vector on the basis of the image feature vector.

The encoding unit 121a associates a time section (segment) of a voice signal in which a name or a state (a concept intended for extraction) representing an object in a frame of an image is described in a voice language with the object by unsupervised learning using the audiovisual embedded network.

In the first embodiment, a globally pooled image feature vector “( )I” as visual information obtained from the image encoder that encodes the image “Cₖ” in the encoding unit 121a is used as the concept embedding vector “e”. Here, the linear transformation unit 122 performs linear transformation on the globally pooled image feature vector “( )I”. The linear transformation unit 122 generates a d′-dimensional vector obtained by the linear transformation as a concept embedding vector “e”.

The information generation unit 12a may express a concept crossing both modalities of image (visual) and voice (auditory) by using a concept embedding vector. That is, the cross-modal embedding vector may be used as the concept embedding vector. The cross-modal embedding vector may be, for example, an embedding vector of an image and a voice.

The acquisition unit 11 acquires the mixed voice signal (input signal). The extraction unit 13 generates mask information on the basis of the mixed voice signal and the concept embedding vector. The mask processing unit 14 estimates the target voice signal “\hat{ }Xₖ” on the basis of the mixed voice signal and the mask information. The loss function in deep distance learning is a function representing a mean square error between the estimated target voice signal “\hat{ }Xₖ” and the reference voice signal “Xₖ” as a loss.

### <Estimation Stage>

The parameters of the information generation unit 12a (audiovisual embedded network) learned in the learning stage are fixed in the estimation stage. Furthermore, the parameters of the extraction unit 13 (each extraction layer) learned in the learning stage are fixed in the estimation stage.

The acquisition unit 11 acquires the mixed voice signal (input signal). The encoding unit 121a acquires a concept specification signal. The encoding unit 121a generates an image feature vector from the concept specification signal using an audiovisual embedded network (for example, see Reference Literature 1).

The encoding unit 121a may convert information of different modalities (images and voices) into vectors of an embedding space (hereinafter, referred to as a “shared embedding space”) capable of expressing features of the different modalities. For example, when the concept specification signal is a still image or a moving image, the encoding unit 121a encodes the input concept specification signal into an image feature vector. For example, when the concept specification signal is a voice, the encoding unit 121a encodes the input concept specification signal into a voice feature vector (voice feature information).

“I∈R^{H×W×d}” represents the image feature map output from the image encoder of the encoding unit 121a. “A∈R^{T′×d}” represents the voice feature map output from the voice encoder of the encoding unit 121a. When the concept specification signal is a still image, “( )I” indicated in Expression (2) represents an image feature vector that is globally pooled in the spatial direction. When the concept specification signal is a moving image, “( )I” represents an image feature vector that is globally pooled in a spatial direction or a temporal direction.

$$\begin{matrix}[ Math . 2 ] & \\ \overline{I} = \frac{1}{HW} {\sum }_{h = 1}^{H} {\sum }_{w = 1}^{W} {I}_{h , w , :} , & ( 2 )\end{matrix}$$

Here, “I_{h,w,:}” represents a d-dimensional vector (image feature vector) indicating coordinates (h, w) in the image feature map. “H” represents the height of the image downsampled by the image encoder. “W” represents the width of the image downsampled by the image encoder. “( )A” indicated in Expression (3) represents a voice feature vector that is globally pooled in the temporal direction.

$$\begin{matrix}[ Math . 3 ] & \\ \overline{A} = \frac{1}{{T}^{′}} {\sum }_{{t}^{′} = 1}^{{T}^{′}} {A}_{{t}^{′} , :} , & ( 3 )\end{matrix}$$

Here, “A_{t′,:}” represents a d-dimensional vector (voice feature vector) indicating the t′-th frame in the voice feature map. “T′” represents the number of time frames of the voice signal downsampled by the voice encoder.

The extraction unit 13 uses the concept embedding vectors derived on the basis of these feature vectors in the shared embedding space for the filtering processing on the mixed voice signal.

The extraction unit 13 extracts a desired element or region from the mixed voice signal on the basis of the concept embedding vector generated according to the concept specification signal (target concept specifier). The extraction unit 13 includes an extraction network (neural network for extraction). The extraction unit 13 generates a “time-frequency mask” representing a desired element or region as mask information “Mₖ∈R^{T×F}” on the basis of the mixed voice signal “Y” and the concept embedding vector “e” input to the extraction network.

Formation of the mask information is, for example, “Mₖ=g(Y, e)”. Here, “g(⋅)” represents an extraction network. The first extraction layer 131 is the first bidirectional long short-term memory (BLSTM) layer (hidden layer) of the extraction network. The connection processing unit 132 multiplies the output of the first extraction layer 131 by the concept embedding vector “e” for each element. As a result, the extraction result by the first extraction layer 131 and the concept embedding vector “e” are multiplied and connected (see Reference Literature 2). The second extraction layer 133a extracts mask information from the result of multiplication and connection by the connection processing unit 132.

The mask processing unit 14 multiplies the mask information “Mₖ” extracted by the second extraction layer 133a by the mixed voice signal “Y” for each element. As a result, the mask processing unit 14 estimates the target voice signal “\hat{ }Xₖ”.

Next, an operation example of the signal filtering device 1a will be described.

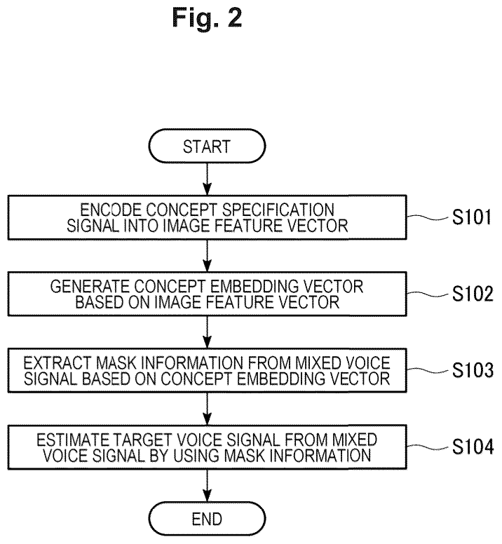

FIG. 2 is a flowchart illustrating an exemplary operation of the signal filtering device 1a according to the first embodiment. The encoding unit 121a encodes the concept specification signal into an image feature vector (d-dimensional vector) (step S101). The linear transformation unit 122 generates a linear transformation result of the image feature vector as a concept embedding vector (step S102). The extraction unit 13 extracts mask information from the mixed voice signal including the target voice signal on the basis of the concept embedding vector (step S103). The mask processing unit 14 estimates the target voice signal from the mixed voice signal using the mask information (step S104).

As described above, the information generation unit 12a generates a concept embedding vector (feature information) of the concept specification signal (related information) of the target voice signal (target signal). The extraction unit 13 extracts mask information from the mixed voice signal (mixed signal) including the target voice signal on the basis of the concept embedding vector. The mask processing unit 14 estimates the target voice signal from the mixed voice signal using the mask information.

Here, the information generation unit 12a encodes the concept specification signal (related information) into a d-dimensional vector (multidimensional vector). The information generation unit 12a generates a linear transformation result of the d-dimensional vector as a concept embedding vector (feature information).

As a result, it is possible to improve the accuracy of extracting a target voice signal from a voice signal (mixed voice signal) in which a voice signal other than the target voice signal and the target voice signal are mixed.

### Second Embodiment

A second embodiment is different from the first embodiment in that mask information is extracted from a mixed voice signal using concept activity information. In the second embodiment, the differences from the first embodiment will be mainly described.

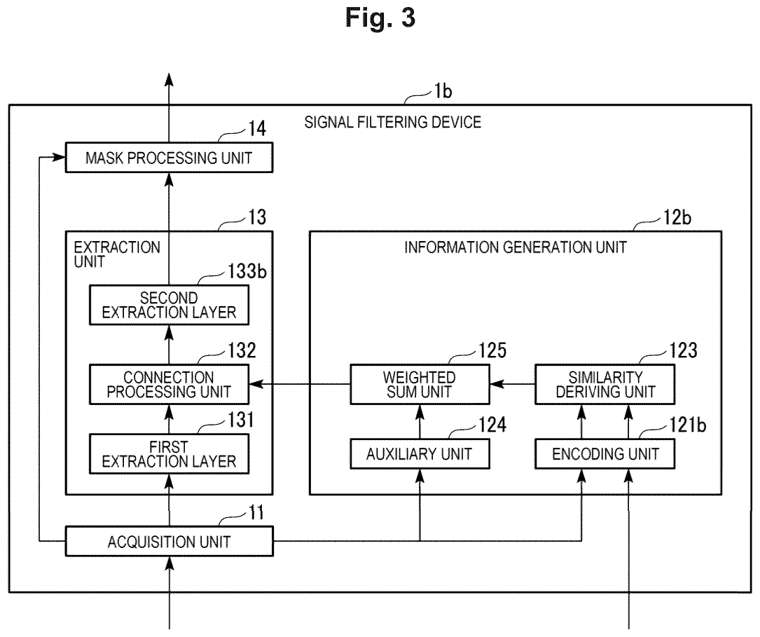

FIG. 3 is a diagram illustrating an exemplary configuration of a signal filtering device 1b according to the second embodiment. The signal filtering device 1b is a device that extracts the target voice signal from the mixed voice signal. The signal filtering device 1b extracts the target voice signal from the mixed voice signal by filtering the mixed voice signal including the voice signal other than the target voice signal and the target voice signal.

The signal filtering device 1b includes an acquisition unit 11, an information generation unit 12b, an extraction unit 13, and a mask processing unit 14. The information generation unit 12b includes an encoding unit 121b, a similarity deriving unit 123, an auxiliary unit 124, and a weighted sum unit 125. The extraction unit 13 includes a first extraction layer 131, a connection processing unit 132, and a second extraction layer 133b.

The information generation unit 12b generates a similarity profile for the concept specification signal. The similarity profile is information indicating an audiovisual correspondence. For example, the similarity profile is information representing the similarity between the image feature and the voice feature in time series. The similarity profile is expressed as an inner product of the image feature vector “I” and the voice feature vector “A” as in Expression (4).

$$\begin{matrix}[ Math . 4 ] & \\ \begin{matrix}{s}_{{t}^{′}} = {max}_{h , w} {I}_{h , w , :} \cdot {A}_{{t}^{′} , :} & ( {t}^{′} = 1 , … , {T}^{′} ) .\end{matrix} & ( 4 )\end{matrix}$$

The information generation unit 12b generates conceptual activity information on the basis of the similarity profile. Since the concept activity information is generated on the basis of the similarity profile, the concept activity information represents a time interval in which a concept intended for extraction is expressed in the mixed voice signal. For example, the concept activity information is information indicating a time section including the spoken voice language “bicycle” about the concept “bicycle” intended for extraction in the mixed voice signal.

The information generation unit 12b generates a concept embedding vector on the basis of the concept activity information. The extraction unit 13 extracts the mask information from the mixed voice signal on the basis of the concept embedding vector.

### <Learning Stage>

Instead of using the mixed voice signal for learning, for example, oracle concept activity information is used for learning. The oracle concept activity information is information obtained as an output of an audiovisual embedded network (for example, see Reference Literature 1) by inputting a reference voice signal of a target voice signal to the audiovisual embedded network.

Since the oracle concept activity information (time series data) is used to generate the concept embedding vector, it is expected that the extraction unit 13 accurately extracts a feature of a specific concept in the target voice signal. In supervised learning of extracting a target voice signal from a mixed voice signal, a concept embedding vector close to a vector indicating a speaker of the target voice signal is generated.

### <Estimation Stage>

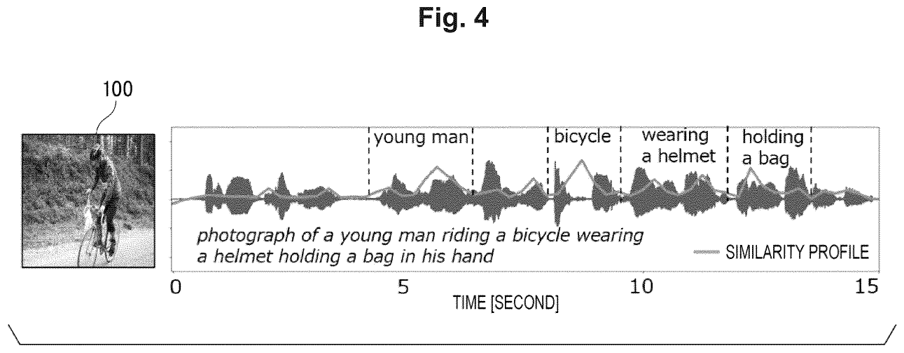

FIG. 4 is a diagram illustrating an example of a similarity profile according to the second embodiment. The audiovisual correspondence is used to generate the concept embedding vector. By using the similarity profile “s_{t′}”, the region (segment) of the voice signal in which the word related to the concept expressed in the image is spoken is identified (see Reference Literature 1).

For example, when the speaker is speaking about a concept specification signal 100 (still image), the similarity profile represents the similarity between the content of the concept specification signal 100 and the content of the voice of the speaker. The concept specification signal 100 illustrated in FIG. 4 includes, for example, an image of a bicycle. Therefore, the similarity profile of the time section in which the word “bicycle” is included in the voice of the speaker is relatively higher than the similarity profile of the time section in which the word “bicycle” is not included.

Hereinafter, it is assumed that voice sections of the respective speakers in the mixed voice signal partially overlap with each other. The information generation unit 12b derives the similarity profile on the basis of the concept specification signal 100 and the mixed voice signal. For example, the encoding unit 121b generates an image feature map of the concept specification signal 100. The encoding unit 121b may generate an image feature vector in the image feature map of the concept specification signal 100. The encoding unit 121b may generate a voice feature vector in the voice feature map of the mixed voice signal.

The similarity deriving unit 123 derives a similarity profile between the image feature vector in the image feature map and the voice feature vector in the voice feature map as in Expression (4). The similarity deriving unit 123 uses the sigmoid function as in Expression (5) to scale convert the similarity profile into a value changing between 0 and 1.

$$\begin{matrix}[ Math . 5 ] & \\ \begin{matrix}{p}_{{t}^{′}} = sigmoid ( {s}_{{t}^{′}} + b ) & ( {t}^{′} = 1 , … , {T}^{′} ) ,\end{matrix} & ( 5 )\end{matrix}$$

Here, “b” is a predetermined parameter that can be learned. The time series of “p_{t′}” exemplified in Expression (5) is the conceptual activity information. That is, the similarity profile scale converted to a value changing from 0 to 1 is the conceptual activity information.

The auxiliary unit 124 includes an auxiliary network. The auxiliary unit 124 acquires a mixed voice signal “yₜ” from acquisition unit 11. The weighted sum unit 125 derives a weighted sum (weighting result) of the output “h(yₜ)” of the auxiliary unit 124 and the conceptual activity information as a conceptual embedding vector. The concept embedding vector is expressed as Expression (6).

$$\begin{matrix}[ Math . 6 ] & \\ e = \frac{1}{{\sum }_{t = 1}^{T} {p}_{t}} {\sum }_{t = 1}^{T} {p}_{t} h ( {y}_{t} ) , & ( 6 )\end{matrix}$$

Here, “h(⋅)” represents an auxiliary network. To ensure that the concept embedding vector is derived from the mixed voice signal, the auxiliary network synchronizes the concept activity information to the mixed voice signal. “yₜ” represents the t-th frame in the mixed voice signal “Y”. A relationship of “T′<T” is established between the length “T′” of the sequence of the conceptual activity information “p_{t′}” and the length “T” of the sequence of the t-th frame “yₜ”. The auxiliary unit 124 linearly interpolates the conceptual activity information “p_{t′}”. The weighted sum unit 125 derives the conceptual activity information “pₜ” of the series of the length “T” on the basis of the linearly interpolated conceptual activity information. The weighted sum unit 125 is associated with an activity-driven extraction network (ADEnet) (see Reference Literature 2). This active-driven extraction network uses information representing a time section spoken by a speaker to extract a target voice signal.

The weighted sum unit 125 may derive the concept embedding vector illustrated in Expression (6) using the similarity profile illustrated in Expression (4) instead of using the time series data of the concept activity information illustrated in Expression (4).

Next, an operation example of the signal filtering device 1b will be described.

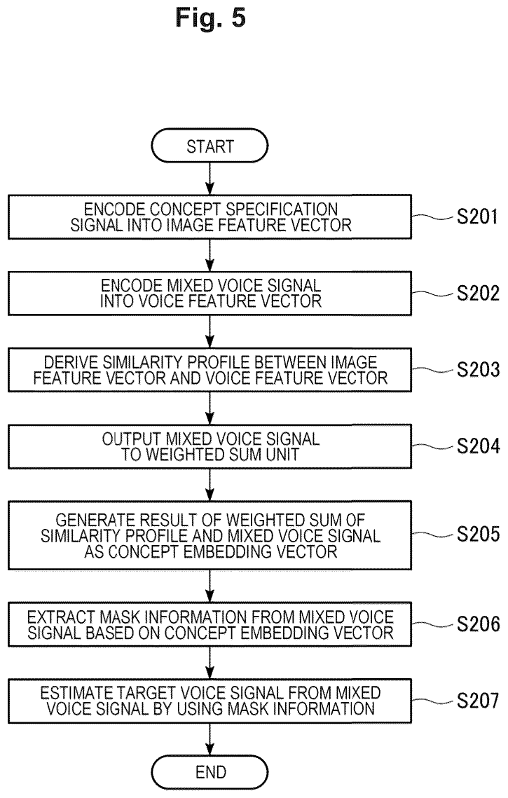

FIG. 5 is a flowchart illustrating an exemplary operation of the signal filtering device according to the second embodiment. The encoding unit 121b encodes the concept specification signal into an image feature vector (step S201). The encoding unit 121b encodes the mixed voice signal into a voice feature vector (step S202). The similarity deriving unit 123 derives a similarity profile between the image feature vector and the voice feature vector (step S203).

The auxiliary unit 124 outputs the mixed voice signal to the weighted sum unit 125 (step S204). The weighted sum unit 125 generates a result of the weighted sum of the similarity profile and the mixed voice signal as a concept embedding vector (step S205). The extraction unit 13 extracts mask information from the mixed voice signal including the target voice signal on the basis of the concept embedding vector (step S206). The mask processing unit 14 estimates the target voice signal from the mixed voice signal using the mask information (step S207).

As described above, the information generation unit 12b generates a concept embedding vector (feature information) of the concept specification signal (related information) of the target voice signal (target signal). The extraction unit 13 extracts mask information from the mixed voice signal (mixed signal) including the target voice signal on the basis of the concept embedding vector. The mask processing unit 14 estimates the target voice signal from the mixed voice signal using the mask information.

The information generation unit 12b encodes the concept specification signal (related information) into an image feature vector (first multidimensional vector). The information generation unit 12b encodes the mixed voice signal (mixed signal) into a voice feature vector (second multidimensional vector). The information generation unit 12b derives a similarity profile (chronological similarity) between the image feature vector and the voice feature vector. The information generation unit 12b generates a result of the weighted sum of the similarity profile and the mixed voice signal (mixed signal) as a concept embedding vector.

As a result, it is possible to improve the accuracy of extracting a target voice signal from a voice signal (mixed voice signal) in which a voice signal other than the target voice signal and the target voice signal are mixed.

### Third Embodiment

The third embodiment is different from the first and second embodiments in that the voice signal in the mixed voice signal is separated for each speaker (sound source). In the third embodiment, differences from the first embodiment and the second embodiment will be mainly described.

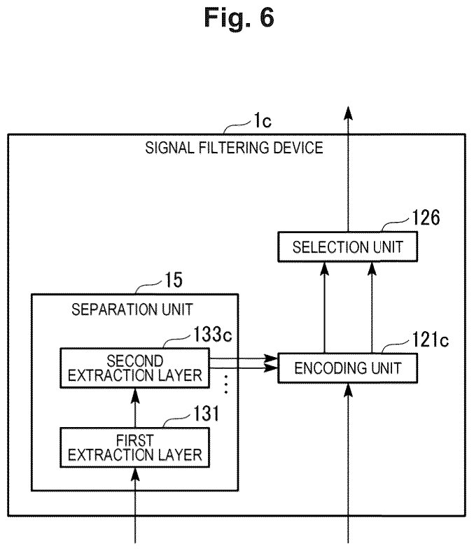

FIG. 6 is a diagram illustrating an exemplary configuration of a signal filtering device 1c according to the third embodiment. The signal filtering device 1c is a device that extracts the target voice signal from the mixed voice signal. The signal filtering device 1c extracts the target voice signal from the mixed voice signal by filtering the mixed voice signal including the voice signal other than the target voice signal and the target voice signal.

The signal filtering device 1c includes a separation unit 15, an encoding unit 121c, and a selection unit 126. The separation unit 15 includes a first extraction layer 131 and a second extraction layer 133c. The encoding unit 121c or the selection unit 126 has an audiovisual embedding network (for example, see Reference Literature 1).

The architecture of the separation network provided in the separation unit 15 is similar to that of the extraction network provided in the extraction unit 13. When the number of speakers (the number of sound sources) of the voice signal in the mixed voice signal is known, the voice signal can be separated for each speaker (sound source). In the third embodiment, the number of sound sources is L. The L voice signals in the mixed voice signal are denoted as {(\tilde{ })X₁, . . . , (\tilde{ })X_{L}}.

The second extraction layer 133c (output layer) separates the voice signal in the mixed voice signal for each voice signal “(\tilde{ })Xₗ” of the speaker. The second extraction layer 133c separates the voice signal in the mixed voice signal for each speaker by using, for example, a method such as permutation invariant training (PIT). The second extraction layer 133c outputs the voice signal of each speaker to the encoding unit 121c.

A still image “Cₖ” as a concept specification signal is input to the encoding unit 121c. A voice signal of each speaker is input to the encoding unit 121c from the second extraction layer 133c. The encoding unit 121c derives an image feature vector “( )Iₖ” of the still image “Cₖ” by using the audiovisual embedding network. The encoding unit 121c derives a voice feature vector “( )Aₗ” of the voice signal of each speaker using the audiovisual embedding network.

The encoding unit 121c outputs the globally pooled image feature vector “( )Iₖ”, the globally pooled voice feature vector “( )A” of the voice signal of each speaker, and the voice signal “(\tilde{ })Xₗ” of each speaker to the selection unit 126.

The selection unit 126 derives similarity “( )Iₖ·( )Aₗ” between the globally pooled image feature vector “( )Iₖ” based on the concept specification signal “Cₖ” and the globally pooled voice feature vector “( )Aₗ” of the voice signal of each speaker. The voice signal “(\tilde{ })Xₗ” of each speaker is input to the selection unit 126 from the separation unit 15 or the encoding unit 121c. The selection unit 126 selects the voice signal “(\tilde{ })Xₗ” having the highest similarity from among the voice signals “(\tilde{ })Xₗ” of the respective speakers as the target voice signal “\hat{ }Xₖ” as shown in Expression (7).

$$\begin{matrix}[ Math . 7 ] & \\ {\hat{X}}_{k} = {arg max}_{{\tilde{X}}_{l}} {\overline{I}}_{k} \cdot {\overline{A}}_{l} . & ( 7 )\end{matrix}$$

Next, an operation example of the signal filtering device 1c will be described.

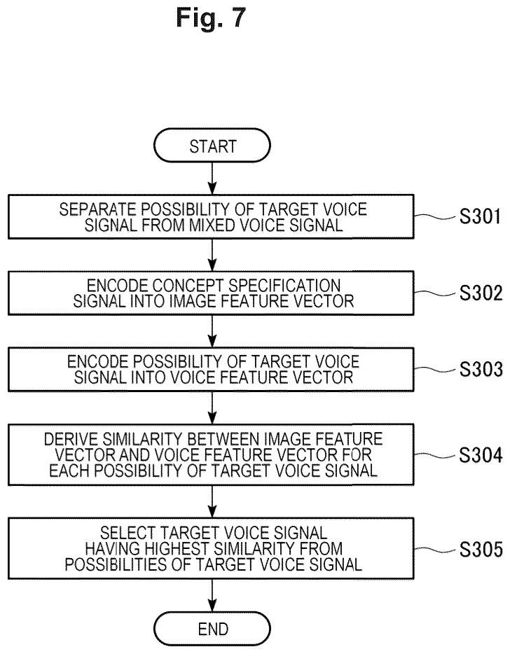

FIG. 7 is a flowchart illustrating an exemplary operation of the signal filtering device according to the third embodiment. The separation unit 15 separates the L possibilities of the target voice signal from the mixed voice signal (step S301). The encoding unit 121c encodes the concept specification signal into an image feature vector (step S302). The encoding unit 121c encodes the L possibilities of the target voice signal into L voice feature vectors (step S303).

The selection unit 126 derives similarity (inner product) between the image feature vector that has been subjected to the global pooling and the voice feature vector that has been subjected to the global pooling, for each possibility for the target voice signal (step S304). The selection unit 126 selects the target voice signal having the highest similarity from the L possibilities of the target voice signal (step S305).

As described above, the separation unit 15 separates L (predetermined number) possibilities (possibility signals) of the target voice signal from the mixed voice signal (mixed signal) as possibilities of the target voice signal to be selected. The L possibilities of the target voice signal are voice signals associated with L predetermined sound sources (for example, the speaker). The separation unit 15 separates the possibility of the target voice signal in the mixed voice signal for each sound source using a method such as PIT.

The encoding unit 121c encodes the concept specification signal (related information) related to the target voice signal into an image feature vector (first feature vector). The encoding unit 121c encodes L possibilities (possibility signals) of the target voice signal into L voice feature vectors (second feature vectors).

The selection unit 126 derives similarity between the image feature vector that has been subjected to the global pooling and the voice feature vector that has been subjected to the global pooling, for each possibility for the target voice signal (possibility signal). The selection unit 126 derives an inner product of the image feature vector and the voice feature vector as the similarity. The selection unit 126 selects a target voice signal (possibility signal) having the highest similarity from the L possibilities of the target voice signal as a final target voice signal (target signal).

As a result, it is possible to improve the accuracy of extracting a target voice signal from a voice signal (mixed voice signal) in which a voice signal other than the target voice signal and the target voice signal are mixed.

### Example of Effect

An example of the evaluation result of the performance of the signal filtering device to extract the target voice signal will be described below.

A data set (place spoken caption dataset) in which voice captions are added to an image data set including a group of images of various scenes and places photographed was used as learning data, and a mixed voice signal of two speakers was created. The voice caption data set includes an image data set and voice captions in English and Japanese. The image group of the image data set is classified into 205 different scene classes. Pairs of image and voice captions (97,555 sets) were extracted from the data set of each language. Only Japanese voice captions are labeled with the gender of the speaker.

To evaluate the effectiveness of the signal filtering device in both languages, the pairs were divided into 90,000 pairs of learning sets, 4,000 pairs of verification sets, and 3,555 pairs of evaluation sets for each language. Thereafter, pre-learning (deep distance learning) of the audiovisual embedded network was performed using the learning set.

“Image-voice caption pairs” belonging to different image classes were selected, and voice captions were mixed at a signal-to-noise ratio from 0 to 5 dB, thereby creating a mixed voice signal of two speakers. As a result, the learning set has 90,000 mixed voice signals. The verification set has 4,000 mixed voice signals. The evaluation set has 3,555 mixed voice signals. The frequency of voice captions was down-sampled to 8 kHz, thereby reducing computational and memory costs.

A 258-dimensional vector in which a real part and an imaginary part of a complex spectrum are connected was used as a feature of input speech. This complex spectrum was obtained from a short time Fourier transform with a window length of 32 ms and a window shift length of 8 ms.

As pre-processing of the image, the dimensions of the image were resized so that the minimum dimension of the image was 256 pixels. A 224×224 central trimming was performed on the resized image. The pixels of the image on which the central trimming was performed were normalized according to the global pixel average and variance.

As an audiovisual embedding network, “ResNet-ResDAVEnet” (see Reference Literature 1) was adopted. The image encoder is “ResNet 50”. When an image of “224×224×3” is input, the image encoder outputs an image feature map of “7×7×1,024”. The height “H” and the width “W” of the image feature map are both 7.

The voice encoder is “ResDAVEnet”. When the 40-dimensional logarithmic mel filter bank spectrogram is input, the voice encoder outputs a voice feature map of “T′×1,024”. This filter bank spectrogram was calculated from the input voice features. The dimension “d” is 1,024. The time resolution “T′” finally becomes “T/16”.

The linear transformation unit 122 illustrated in FIG. 1 includes a fully connected layer having 896 units (d′=896). The auxiliary unit 124 (auxiliary network) illustrated in FIG. 3 has two fully connected layers. These two fully connected layers have 200 hidden units, 896 hidden units, and a rectified linear unit (ReLU) activation function. Therefore, the dimension of the concept embedding vector is 896.

The extraction network of the extraction unit 13 and the separation network of the separation unit 15 each include four bidirectional long-term short-term storage layers each including 896 units. The extraction network of the extraction unit 13 and the separation network of the separation unit 15 have 896 units of linear mapping layers after each bidirectional long short term storage layer. This linear mapping layer connects the forward output of a long short term memory (LSTM) and the backward output of the LSTM.

In order for the extraction unit 13 to estimate the mask information (time-frequency mask), one fully connected layer and a ReLU activation function were used. The connection processing unit 132 connects the output of the first bidirectional long short term storage layer in the extraction unit 13 (extraction network) and the concept embedding vector.

In the learning of the separation network of the separation unit 15, the number “L” of sound sources is 2. The total number of speakers “K” is two. The initial learning rate is 0.0001. “Adam” was used as a learning optimization method, and gradient clipping was performed.

The target voice signal extracted by the signal filtering device was evaluated using a signal-to-distortion ratio (SDR). The signal-to-distortion ratio represents performance of extracting a target voice signal of each speaker from a mixed voice signal. The signal-to-distortion ratio (SDR) scores were averaged in all experimental results.

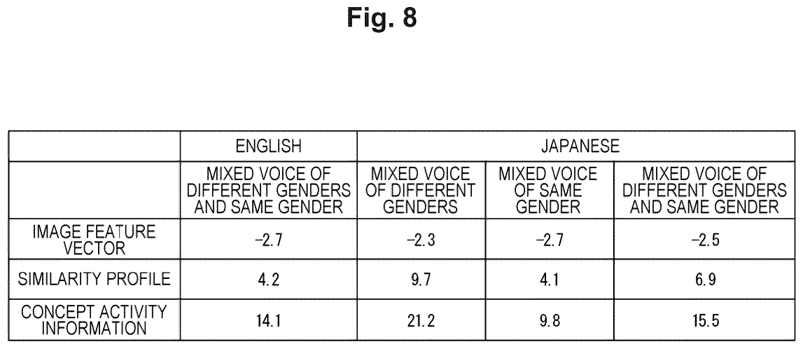

FIG. 8 illustrates examples of signal-to-distortion ratio (SDR) scores (dB) averaged for a target voice signal in the first embodiment and the second embodiment. The value in the column of the item “mixed voice of different genders” indicates the signal-to-distortion ratio score for mixed voice signals of different genders. The value in the column of the item “mixed voice of the same gender” indicates the signal-to-distortion ratio score for mixed voice signals of the same gender. The value in the column of the item “mixed voice of different genders and the same gender” indicates the signal-to-distortion ratio score for mixed voice signals of different genders and the same gender.

The item “image feature vector” indicates the signal-to-distortion ratio score in the signal filtering device 1a of the first embodiment. The item “similarity profile” indicates the signal-to-distortion ratio score when the similarity deriving unit 123 of the signal filtering device 1b of the second embodiment outputs the similarity profile to the weighted sum unit 125. The item “concept activity information” indicates a signal-to-distortion ratio score when the similarity deriving unit 123 of the signal filtering device 1b of the second embodiment outputs the concept activity information to the weighted sum unit 125.

As a configuration for generating the concept embedding vector, in order to confirm which one of the image feature vector, the similarity profile, and the concept activity information is the best, a mixed voice of two speakers having no overlap in the time interval is used for each evaluation of the signal filtering device 1a and the signal filtering device 1b.

As a result of each evaluation, when the concept embedding vector generated using the concept activity information is used for extraction, the performance of the extraction of the target voice signal is the highest. Hereinafter, in the target voice signal extraction method, the concept embedding vector is generated using the concept activity information.

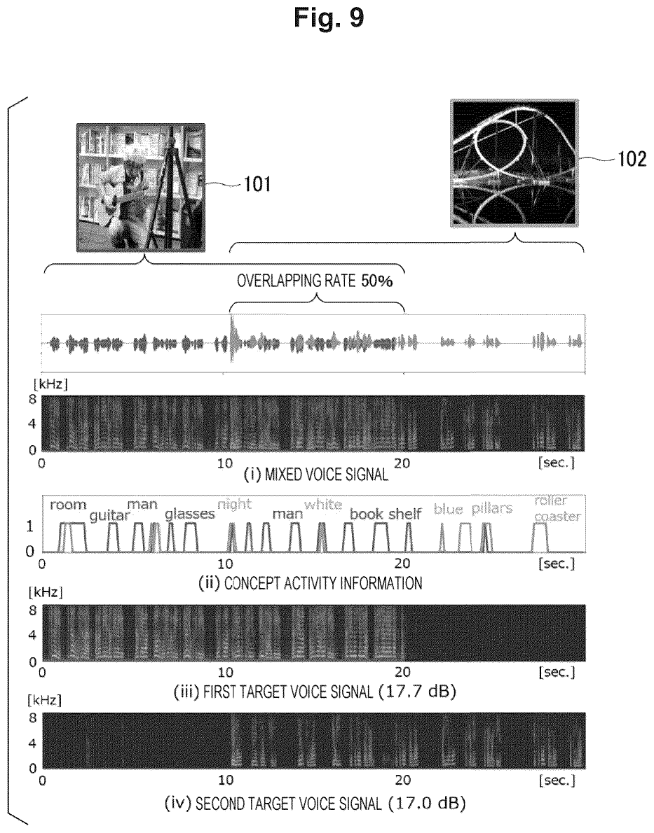

FIG. 9 illustrates an example of extracting a target voice signal in the second embodiment (extraction method).

The concept specification signal 101 is an image of a scene where a man wearing glasses is playing a guitar in a bookstore. The concept specification signal 102 is an image of a blue pillar and a night scene of a roller coaster. A first speaker (not illustrated) is speaking with a concept specification signal 101 as a topic. A first target voice signal is a voice signal of the first speaker. A second speaker (not illustrated) is speaking with a concept specification signal 102 as a topic. A second target voice signal is a voice signal of the second speaker.

Even in a time section in which the voice of the first speaker and the voice of the second speaker overlap in the mixed voice signal, the signal filtering device 1b can extract the first target voice signal and the second target voice signal. In particular, each time at which the value of the “concept activity information” becomes 1 corresponds to, for example, a concept (for example, a voice language “glasses”, a voice language “man”, and the like) associated with a remarkable object (for example, a male wearing glasses) in the image of the concept specification signal 101. The same applies to the image of the concept specification signal 102. Each time at which a concept appears in the concept specification signal serves as a clue, and a concept embedding vector is derived. The concept embedding vector is used to generate mask information for extracting the target voice signal from the mixed voice signal.

The extraction performance (SDR score) of the first target voice signal is 17.7 dB. The extraction performance (SDR score) of the second target voice signal is 17.0 dB. As described above, it is possible to preferably extract the voices of the two speakers from the mixed voice.

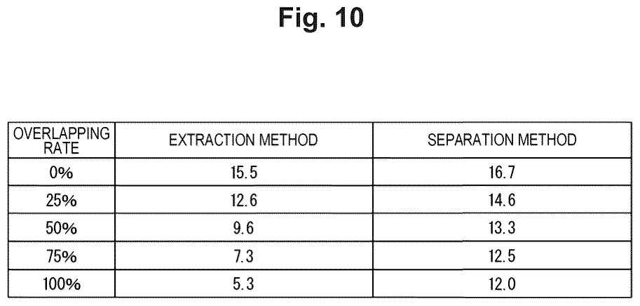

FIG. 10 illustrates an example of a signal-to-distortion ratio score for each overlap ratio in the second embodiment (extraction method) and the third embodiment (separation method). Using the mixed voice signals of the two speakers, the extraction performance of the signal filtering device 1b (extraction method using the concept activity information) and the extraction performance of the signal filtering device 1c (separation method) are compared. The mixed voice signal of the speaker was obtained by mixing Japanese voice captions at five different overlap ratios.

The extraction performance of the signal filtering device 1b and the extraction performance of the signal filtering device 1c tend to be similar as the overlap ratio is lower. The higher the overlap ratio, the lower the extraction performance of the signal filtering device 1b and the extraction performance of the signal filtering device 1c.

The extraction performance of the signal filtering device 1c is 10 dB or more even if the overlap ratio is 100%. However, the signal filtering device 1c needs to acquire in advance information indicating the number of speakers (the number of sound sources) of the target voice signal included in the mixed voice signal. It is effective to selectively use the signal filtering device 1b and the signal filtering device 1c depending on whether the number of speakers is known and the overlap ratio between the target voice signals.

Next, an example of each assumed use scene will be described.

As a first use scene, a situation is assumed in which a presenter is explaining content of a poster (a concept intended for extraction) in a booth in a poster venue such as an academic society or an exhibition. The voice of the target presenter (target voice signal) is difficult to hear due to irrelevant voice and noise. The signal filtering device of each of the above embodiments utilizes the content of the poster (image) as the concept specification signal (auxiliary information). The signal filtering device of each of the above embodiments extracts the voice of the presenter from the voice in which various sounds are mixed. This makes it possible to easily hear the voice of the presenter.

As a second use scene, a situation is assumed in which a target moving image content (a concept intended for extraction) is searched from a large amount of video content in television broadcasting, video distribution, or the like. The signal filtering device according to each of the above embodiments utilizes, as a concept specification signal (auxiliary information), a still image and a moving image including an image representing a concept (a concept intended for extraction) as a search target. For example, the signal filtering device utilizes a still image and a moving image including an image representing a bicycle as a search target as a concept specification signal. The signal filtering device extracts a target voice signal describing a concept of a search target from a mixed voice signal associated with a large amount of moving image content. For example, the signal filtering device extracts a target voice signal “bicycle” describing the bicycle from a mixed voice signal associated with a large amount of moving image content including a moving image of the bicycle. As a result, it is possible to search for target moving image content (for example, a moving image of a bicycle) associated with the extracted mixed voice signal.

As a third use scene, a situation is assumed in which voice recognition for a target voice is performed and subtitles are assigned to instruction contents in television broadcasting and moving image distribution. The instruction content is content for describing a concept intended for extraction using a still image and a moving image, and is, for example, a moving image for describing a dish, a moving image for describing a creation method, and a moving image of a training material. In the instruction content, since the target voice is buried in the background sound and the noise, it is often difficult to perform voice recognition for the target voice. The signal filtering device according to each of the above embodiments utilizes, as a concept specification signal (auxiliary information), a still image and a moving image describing a concept as a description target. By extracting the target voice signal of the speaker, the performance of voice recognition is improved.

As a fourth use scene, a situation in which it is used for music is assumed. Hereinafter, an acoustic signal that is a mixed voice signal and in which an acoustic signal other than the acoustic signal intended for extraction and the acoustic signal intended for extraction are mixed is referred to as a “mixed acoustic signal”. For example, an acoustic signal obtained by mixing sounds of a plurality of types of musical instruments may be input to the signal filtering device as the mixed voice signal of each of the above embodiments. The signal filtering device utilizes a still image or a moving image including an image of a target musical instrument as a concept specification signal (auxiliary information). The acoustic signal extracted as the sound of the target musical instrument is easily heard.

As a fifth use scene, a situation is assumed in which an acoustic signal associated with a concept intended for extraction is searched from the mixed acoustic signal. The mixed acoustic signal is, for example, an acoustic signal recorded by a microphone (for example, a monitoring microphone) installed outdoors. The mixed acoustic signal includes, for example, an environmental sound such as a car sound. The still image and the moving image associated with the concept intended for extraction are used as a concept specification signal (auxiliary information).

As a sixth use scene, instead of the concept specification signal (auxiliary information) being an image signal, the concept specification signal may be a voice signal. When the concept specification signal is a voice signal, the signal filtering device may extract, from the mixed voice signal, a target voice signal of a speaker speaking about content close to the content (concept) of a topic. When the first speaker speaking English and the second speaker speaking Japanese are speaking about the same concept (for example, the content of the same image), the signal filtering device may extract one of the English voice signal of the first speaker and the Japanese voice signal of the second speaker from the mixed voice signal by using the language used in the target voice signal as the concept specification signal. The signal filtering device may remove one of the English voice signal of the first speaker and the Japanese voice signal of the second speaker from the mixed voice signal by using the language used in the target voice signal or the language not used in the target voice signal as the concept specification signal.

### Hardware Configuration Example

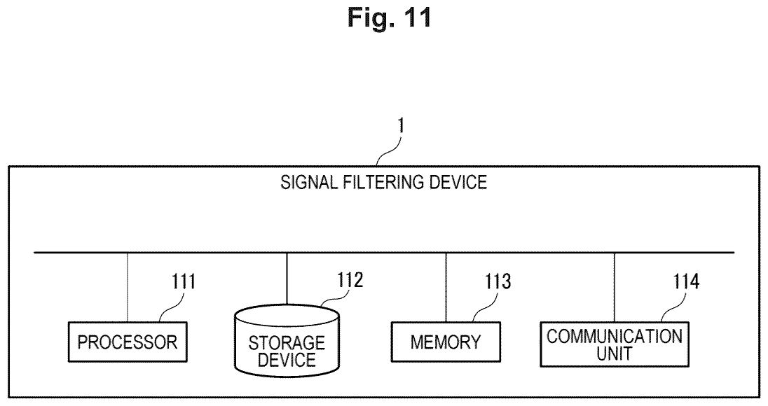

FIG. 11 is a diagram illustrating an exemplary hardware configuration of the signal filtering device 1 according to each embodiment. The signal filtering device 1 corresponds to each of the signal filtering device 1a, the signal filtering device 1b, and the signal filtering device 1c. Some or all of the functional units of the signal filtering device 1 are realized as software by causing a processor 111 such as a central processing unit (CPU) to execute a program stored in a storage device 112 including a non-volatile recording medium (non-transitory recording medium) and a memory 113. The program may be recorded in a computer-readable non-transitory recording medium. The computer-readable non-transitory recording medium is, for example, a portable medium such as a flexible disk, a magneto-optical disk, a read only memory (ROM), or a compact disc read only memory (CD-ROM), or a non-transitory recording medium such as a storage device such as a hard disk built in a computer system. The communication unit 114 performs a predetermined communication process. The communication unit 114 may acquire data and a program.

Some or all of the functional units of the signal filtering device 1 may be implemented by using, for example, hardware including an electronic circuit (electronic circuit or circuitry) using a large scale integrated circuit (LSI), an application specific integrated circuit (ASIC), a programmable logic device (PLD), a field programmable gate array (FPGA), or the like.

As described above, the embodiment of the present invention has been described in detail with reference to the drawings. On the other hand, the specific configuration is not limited to the embodiment, and includes design without departing from the spirit of the present invention.

### INDUSTRIAL APPLICABILITY

The present invention is applicable to a system that filters a signal.

### REFERENCE SIGNS LIST

1, 1a, 1b, 1c Signal filtering device
11 Acquisition unit
12a, 12b Information generation unit
13 Extraction unit
14 Mask processing unit
15 Separation unit
100 Concept specification signal
101 Concept specification signal
102 Concept specification signal
111 Processor
112 Storage device
113 Memory
114 Communication unit
121a, 121b Encoding unit
123 Similarity deriving unit
124 Auxiliary unit
125 Weighted sum unit
126 Selection unit
131 First extraction layer
132 Connection processing unit
133a, 133b, 133c Second extraction layer

1. A signal filtering device comprising:
a processor; and
a storage medium having computer program instructions stored thereon, when executed by the processor, perform to:
separate a predetermined number of possibility signals from a mixed signal as possibilities of a target signal;
encode related information of the target signal into a first feature vector and encodes the predetermined number of possibility signals into the predetermined number of second feature vectors; and
derive a similarity between the first feature vector and the second feature vector for each of the possibility signals, and selects a possibility signal of the possibility signals having the highest similarity as the target signal from the predetermined number of possibility signals.

2. The signal filtering device according to claim 1, wherein the computer program instructions further perform to derive an inner product of the first feature vector and the second feature vector as the similarity.

3. The signal filtering device according to claim 1,
wherein the predetermined number of possibility signals are voice signals associated with the predetermined number of sound sources, and the computer program instructions further perform to separate the possibility signals in the mixed signal for each of the sound sources.

4. A signal filtering method performed by a signal filtering device, the signal filtering method comprising steps of:
separating a predetermined number of possibility signals from a mixed signal as possibilities of a target signal;
encoding related information of the target signal into a first feature vector and encoding the predetermined number of possibility signals into the predetermined number of second feature vectors; and
deriving a similarity between the first feature vector and the second feature vector for each of the possibility signals, and selecting a possibility signal of the possibility signals having the highest similarity as the target signal from the predetermined number of possibility signals.

5. A non-transitory computer-readable medium having computer-executable instructions that, upon execution of the instructions by a processor of a computer, cause the computer to function as the signal filtering device according to claim 1.
